(19) United States
(12) Patent Application Publication
(10) Pub. No.: US 2007/0056752 A1
(43) Pub. Date: Mar. 15, 2007

(54) Method and apparatus for reducing the detrimental effects of a fire

(76) Inventors: Goran Sundholm, Tuusula (FI); Harry Metzger, Kerava (FI)

Correspondence Address: LADAS & PARRY, 26 WEST 61ST STREET, NEW YORK, NY, 10023, US

(21) Appl. No.: 10/568,634

(22) PCT Filed: Sep. 3, 2004
(86) PCT No.: PCT/FI04/00512

§ 371 Date: Feb. 16, 2006

(30) Foreign Application Priority Data
Sep. 3, 2003 (FI) 20031246

(51) Int. Cl. A62C 2/00; A62C 3/06; A62C 35/00; A62C 37/14

(52) U.S. Cl. 169/46; 169/56; 169/58; 169/16

(57) ABSTRACT

A method for reducing the adverse effects of a fire, in which method smoke and combustion gases are removed from a space by spraying through at least one first spray head (2) a mist of a medium into a duct part (1) leading away from the space so as to generate a suction from the space into the duct near the orifice (4) of the duct (1). In a first step, the first spray head (2) is activated and, when necessary, a connection is opened from the space into the duct part (1) via the orifice (4) of the duct part by opening a shutter element (5) and, in a second step, the connection from the space into the duct part (1) is closed by means of the shutter element (5) at least when the temperature of the combustion gases and/or smoke exceeds a predetermined value in the duct part or in its vicinity and, when necessary, the spraying through the first spray head (2) in the duct part (1) is stopped.

### BACKGROUND OF THE INVENTION

The present invention relates to a method as defined in the preamble of claim 1 for reducing the detrimental effects of a fire, in which method smoke and fire gases are removed from a space by spraying through at least one first spray head a mist of a medium into a duct part leading away from the space so as to generate a suction from the space into the duct near the orifice of the duct. The invention also relates to an apparatus as defined in claim 6.

Fires produce smoke, which causes significant damage and even loss of human life, especially in connection with fires in apartments, hotels and ships. In a prior-art solution, to reduce the detrimental effects of smoke, at least one spray head mounted inside a ventilation duct is used to spray a fire extinguishing medium at a high pressure when activated. Such a solution is disclosed in U.S. Pat. No. 5,957,212, wherein smoke is passed from a space into an air conditioning duct by spraying a fire extinguishing medium through a nozzle in the duct so as to produce a suction from the space into the duct.

One of the drawbacks of prior-art technology is that a fire may also be propagated through air conditioning ducts and a spray head provided in the duct may not be able to cool down hot fire gases sufficiently in extreme conditions.

The object of the present invention is to achieve a solution of a completely new type that can be used to avoid the drawbacks of prior art.

### BRIEF DESCRIPTION OF THE INVENTION

The method of the invention is mainly characterized in that, in a first step, a first spray head is activated and, when necessary, a connection is opened from the space into a duct part via the orifice of the duct part by opening a shutter element and, in a second step, the connection from the space into the duct part is closed by means of the shutter element at least when the temperature of the fire gases and/or smoke exceeds a predetermined value in the duct part or in its vicinity and, when necessary, the spraying through the first spray head in the duct part is stopped.

The method of the invention is additionally characterized by what is stated in claims 2-5.

The apparatus of the invention is mainly characterized in that the apparatus comprises at least one shutter element in conjunction with the orifice of a duct, said element being movable between at least two positions, of which a first position is an open position, in which the passage through the orifice of the duct into the duct is open, and a second position is a closed position, in which the passage through the orifice of the duct into the duct is closed, and an actuating mechanism for operating the shutter element.

The apparatus of the invention is additionally characterized by what is stated in claims 7-11.

The solution of the invention has numerous significant advantages. By arranging an apparatus according to the invention in conjunction with a space, efficient fire extinction and smoke removal from the space will be achieved. By providing the inlet orifice of the duct with a shutter element, it will be possible to prevent excessively hot fire gases and smoke from getting into the duct part, such as a ventilation duct, and thus to prevent possible propagation of fire through the duct system. At the same time, effective removal of smoke and fire gases is achieved. By using an aqueous medium sprayed from a spray head, a very powerful purifying effect on smoke and fire gases is produced in the duct part. By causing the gases to be drawn from the space into the duct part by the suction produced by the spray head and purifying at least a proportion of them, the adverse effect of smoke is minimized. The use of a medium-operated device for actuating the shutter element allows an effective combination of spraying through the first spray head and an opening/closing movement of the shutter element. By providing in conjunction with the orifice of the duct a temperature monitoring element, preferably an ampoule reacting to temperature, and a valve element reacting to an impulse from the monitoring element, e.g. from the bursting of an ampoule, an effective solution for closing the shutter element and/or activating a second spray head is achieved. The valve elements and triggering element with an ampoule that are needed for the application of the Invention can be implemented as a compact assembly that can be easily arranged in conjunction with a suitable duct part.

### BRIEF DESCRIPTION OF THE DRAWINGS

In the following, the invention will be described in detail with reference to an example and the attached drawings, wherein

FIG. 1 presents a prior-art solution, and

FIG. 2 presents an apparatus according to the invention.

### DETAILED DESCRIPTION OF THE INVENTION

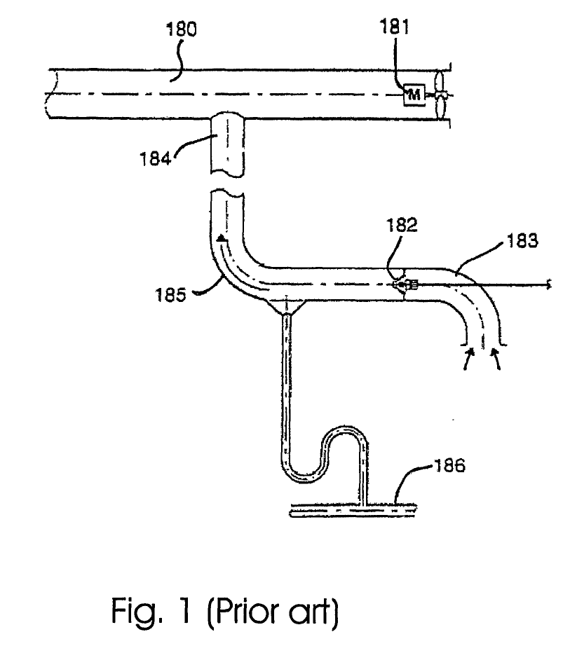

FIG. 1 presents a prior-art solution in which a duct part 183 connected to a ventilation pipe 180 is provided with a spray head 182 which, when activated, sprays a fire extinguishing mist, especially water mist into the duct, producing a suction from the space into the duct part 183, the suction causing smoke to drift into the duct through its open orifice. The duct part has a bend 185 or the like, and the droplets of the spray hit this bend with the result that most of the liquid flows into the discharge pipe 186. The spray head may be activated on the basis of data obtained from e.g. a smoke detector or fire detector or as a result of manual activation. A more detailed description of this solution can be found in U.S. Pat. No. 5,957,212, among others.

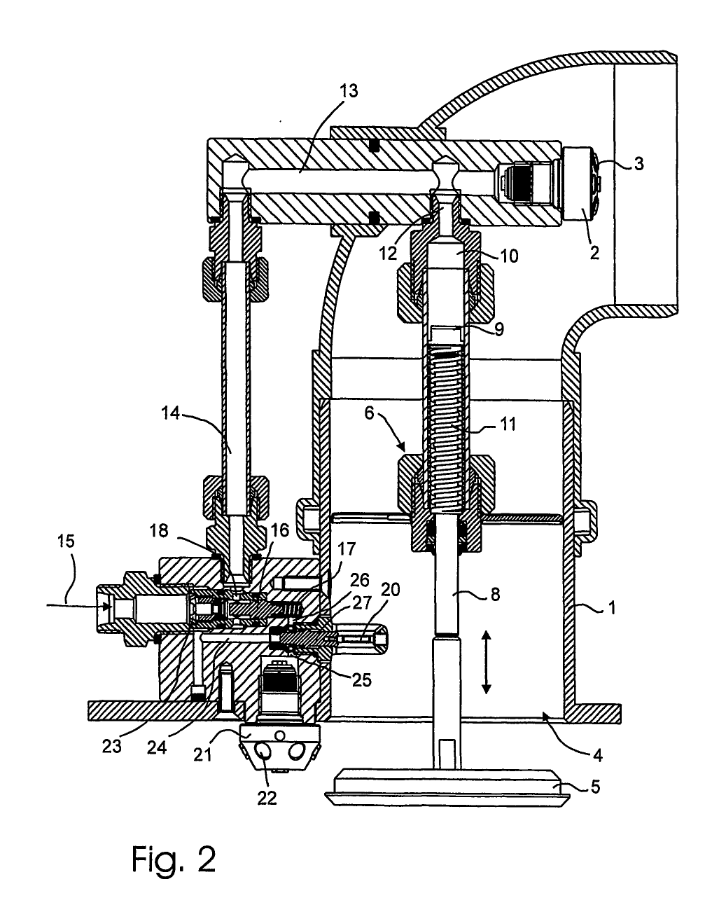

An apparatus utilizing the method of the invention is presented in FIG. 2. In the method, smoke and fire gases are removed from a space by spraying through at least one first spray head 2 a mist of a medium into a duct part 1 leading out of the space so that a suction from the space into the duct is generated in the vicinity of the orifice 4 of the duct 1. In a first step, a first spray head 2 is activated and, when necessary, a connection from the space into the duct part 1 is opened via the orifice 4 of the duct part by opening a shutter element 5 and, in a second step, the connection from the space into the duct part 1 is closed by means of the shutter element 5 at least when the temperature of the fire gases and/or smoke exceeds a predetermined value in the duct part or in its vicinity and, when necessary, the spraying through the first spray head 2 in the duct part 1 is stopped. In the next step in the method, fire extinguishing medium is sprayed through at least one second spray head 21 into the space into which the orifice 4 of the duct has been open. The aim is to cool down the fire gases and at the same time to extinguish any fire in the vicinity of the spraying point.

The operation of the shutter element 5 is linked to the operation of the first spray head 2 in such a way that the passage through the orifice 4 of the duct part 1 into the duct part is open at least when the first spray head 2 is in the activated state, and that the passage is closed by the shutter element 5 typically when the supply of medium to the first spray head 2 is stopped. In a preferred embodiment of the method, the temperature of the combustion gases is monitored, typically using a heat sensitive element, such as an ampoule 20, and when the temperature exceeds a set value, the passage of the medium to the first spray head and/or to the actuator 6 of the shutter element is closed on the basis of an impulse obtained from the heat sensitive element, e.g. when the ampoule is broken. The shutter element 5 is moved to an open position, in which a connection is provided between the space and the duct part via the orifice 4, when the force produced by the pressure of the medium exceeds the force of a counter-element 11, especially a spring element, and the shutter element 5 is moved into a closed position, in which the connection via the orifice 4 into the duct element is closed, when the force produced by the pressure of the medium falls below the force of the counter-element 11, especially a spring element. The apparatus of the invention comprises at least one spray head 2 which, when activated, has been arranged to spray a mist of a medium in a duct part 1 leading out of a space so that a suction from the space into the duct is created near the orifice 4 of the duct 1. The apparatus comprises at least one shutter element 5 In conjunction with the orifice 4 of the duct, which shutter element can be moved between at least two positions, of which a first position is an open position, in which the passage through the orifice of the duct into the duct is open, and a second position is a closed position, in which the passage through the orifice 4 of the duct 1 into the duct is closed, and an actuating mechanism 6 for operating the shutter element.

In the embodiment presented in FIG. 2, the actuating mechanism 6 operating the shutter element 5 comprises cylinder-piston combination. The actuator 6 of the shutter element 6 is functionally connected to the supply of medium to the first spray head 2.

The apparatus further comprises a temperature monitoring device 20. Based on an impulse obtained from this device, the shutter element 5 is moved to the second position, the closed position, when necessary. The apparatus further comprises at least one second spray head 21, which has been fitted to spray fire extinguishing medium in the space, preferably in the vicinity of the orifice of the duct 1, at least on the basis of the impulse given by the temperature monitoring device 20. The temperature monitoring device 20 is e.g. an ampoule that will burst at a given temperature. As a result of the bursting of the ampoule, a valve element 27 opens a passage 25 for the extinguishing medium to the second spray head 21 and/or causes a second valve element 16 to move so as to close the passage 18 to the first spray head 2 and/or to the actuator 6 of the shutter element.

In the following, the embodiment illustrated in FIG. 2 will be described in more detail. Here, a duct 1, e.g. a ventilation duct or a duct part leading into a ventilation duct, is provided with a spray head 2. The spray head 2 comprises at least one nozzle 3, preferably a plurality of nozzles, by means of which, when activated, a mist of a medium, typically a mist of a liquid medium, especially a mist of water, is produced so that a suction from the orifice 4 of the duct part into the duct part towards the spray head is created. Arranged in conjunction with the orifice 4 of the duct is a shutter element 5, such as a clappet, which can be opened and closed by the shutter element actuator 6. In the embodiment illustrated in the figure, the actuating devices 6 comprise a cylinder-piston combination, the shutter element 5 being mounted on the piston rod 8 of the combination. The piston 9 has been arranged to be movable in a cylinder space 10, into which cylinder space a flow path leads from the conduit 13 leading to the spray head 2. When a pressure medium is passed into the cylinder space 10, the piston 9 will move into the situation illustrated in FIG. 2 (from above downwards as seen in FIG. 2), causing the shutter element 5, such as a clappet, to move outwards from the orifice 4 of the duct part 1. As a result, a flow path from the space into the duct via the orifice 4 is opened. Correspondingly, when the pressure in the cylinder space 10 of the shutter element actuator is reduced, the shutter element 5 will be moved (upwards in FIG. 2) by the action of the spring element 11 comprised in the actuating device to close the orifice 4 so that the flow path from the space via the orifice 4 into the duct part 1 is closed.

The apparatus is provided with a valve element 16 arranged between the extinguishing medium supply pipe 15 and the conduit 13, 14 leading to the first spray head 2. The valve element comprises a plunger, which in its closed position closes the flow path from the supply pipe to the conduit 13, 14 leading to the spray head 2. In FIG. 2, the plunger 16 is in an open position, so the flow path 18 from the supply pipe 15 to the conduit 13, 14 leading to the spray head 2 is open. The valve element comprises a spring element 17 arranged on the opposite side of the plunger 16 as seen in the direction of supply, and consequently the valve element is opened when the pressure acting on the crosssectional area of the plunger element on the supply-pipe side of the plunger element exceeds the force acting on the opposite side, i.e., in the situation illustrated in FIG. 2, the spring force of the spring element 17.

The solution of the invention also comprises a triggering device 20 arranged in the vicinity of the orifice of the duct element, preferably inside the orifice. The device presented in the figure comprises an ampoule 20 which will burst when the temperature at this point rises to a set value. When the temperature of the gases flowing around and near the triggering device rises above the value set for the ampoule, the latter will burst, thus opening a flow path 24, 25 to the second spray head 21 and, on the other hand, a second flow path 24, 26 to that side of the plunger of the first valve element that lies opposite to the side facing towards the medium supply pipe. In this situation, the pressures acting on either end face area of the plunger 16 are equal, and consequently the force of the spring element moves the plunger into the closed position. As a result, the flow path to the conduit elements leading to the spray head 2 is closed, the spraying into the duct being thus stopped. Correspondingly, the shutter element 5 at the orifice 4 of the duct closes the flow path into the duct 1. This prevents the entry of excessively hot combustion gases into the duct and, on the other hand, the propagation of fire through the duct 1.

The second spray head 21 starts spraying extinguishing medium in the vicinity of the duct.

The apparatus is triggered e.g. as a result of a control command coming from a smoke, heat or fire detector, or manually. When this happens, fire extinguishing medium is supplied through the valve element into the conduits 13, 14 leading to the nozzle 2. The pressure of fire extinguishing medium causes the shutter element 5 closing the orifice 4 of the duct 1 to open, and the spray head 2 starts spraying the fire extinguishing medium into the duct, thus creating a suction from the orifice 4 into the duct. As a result, smoke is removed from the space into which the orifice 4 of the duct opens. At the same time, the spraying creates an intensive suction in the duct end near the orifice 4, and consequently smoke and fire gases drift from the space into the duct through the orifice 4.

The spray head 2 is preferably of a type that creates a suction in its vicinity. Some of the combustion gases drift in the duct 1 Into the mist spray produced by the spray head 2 and are dissolved and/or adsorbed into the mist-like aqueous mist of medium. These combustion gases remain dissolved and/or adsorbed in the aqueous mist of medium in the duct. Thus, by using the apparatus of the invention, the space can be effectively cleaned of combustion gases and smoke so as to minimize their adverse effects.

Arranged in conjunction with the duct 1 are preferably means for collecting combustion gas-soiled mist. The collecting part is typically a branch, bend, necking or the like formed in the duct part and placed in the duct between the spray head and the duct outlet. The collecting part may also consist of a net or sieve formed in the duct. From the collecting part, the soiled medium is typically conducted into a collecting container (not shown) or e.g. into a sewer.

When the combustion gases passed into the duct are too hot, the orifice 4 leading into the duct is closed by the shutter element 5 and the spraying into the duct is stopped. According to the invention, this function is typically implemented using a temperature-responding triggering device 20, which releases the plunger 27 of the second valve element so that a flow path for the pressure medium is opened to the opposite side of the plunger of the first valve element, whereupon the spring element moves the plunger 16 to the left in the figure, with the result that the plunger 16 closes the passage 18 through the pipe elements 13, 14 to the first spray head and to the spray head actuator 6.

The medium used Is typically an aqueous liquid and/or a mixture of an aqueous liquid and a gas. The spraying heads are used to spray a mist of medium, especially water mist. The droplet size (Dv 90) of the mist of extinguishing medium is typically below 200 micrometers. The extinguishing medium is sprayed at a high pressure, preferably 10-300 bar. In connection with the method typically a pump unit with a constant-pressure pump is used.

It is obvious to the person skilled in the art that the invention is not limited to the embodiments described above, but that it may be varied within the scope of the claims presented below. In some instants in the description, several features have been used in connection with each other. In the invention, the features can also be used separately from each other.

1. A method for reducing the adverse effects of a fire, in which method smoke and combustion gases are removed from a space by spraying through at least one first spray head (2) a mist of a medium into a duct part (1) leading away from the space so as to generate a suction from the space into the duct near the orifice (4) of the duct (1), characterized in that, in a first step, the first spray head (2) is activated and, when necessary, a connection is opened from the space into the duct part (1) via the orifice (4) of the duct part by opening a shutter element (5) and, in a second step, the connection from the space into the duct part (1) is closed by means of the shutter element (5) at least when the temperature of the combustion gases and/or smoke exceeds a predetermined value in the duct part or in its vicinity and, when necessary, the spraying through the first spray head (2) in the duct part (1) is stopped.

2. A method according to claim 1, characterized in that, in the next step, fire extinguishing medium is sprayed through at least one second spray head (21) into the space into which the orifice (4) of the duct has been open.

3. A method according to claim 1, characterized in that the operation of the shutter element (5) is linked to the operation of the first spray head (2) in such a way that the passage through the orifice (4) of the duct part (1) into the duct part is open at least when the first spray head (2) is in the activated state, and that the passage is closed by the shutter element (5) typically when the supply of medium to the first spray head (2) is stopped.

4. A method according to claim 1, characterized in that the temperature of the combustion gases is monitored, typically using a heat sensitive element, such as an ampoule (20), and when the temperature exceeds a set value, the passage (18) of the medium to the first spray head and/or to the actuator (6) of the shutter element is closed on the basis of an impulse obtained from said heat sensitive element, e. g. when the ampoule bursts.

5. A method according to claim 1, characterized in that the shutter element (5) is moved into an open position, in which a connection is provided between the space and the duct part via the orifice (4) when the force produced by the pressure of the medium exceeds the force of a counter-element (11), especially a spring element, and the shutter element (5) is moved into a closed position, in which the connection via the orifice (4) into the duct element is closed, when the force produced by the pressure of the medium falls below the force of the counter-element (11), especially a spring element.

6. An apparatus for reducing the adverse effects of a fire, said apparatus comprising at least one spray head which, when activated, has been arranged to spray a mist of a medium in a duct part (1) leading out of a space so that in the vicinity of the orifice (4) of the duct (1) a suction from the space into the duct (1) is created, characterized in that the apparatus comprises at least one shutter element (5) placed in conjunction with the orifice (4) of the duct and movable between at least two positions, of which a first position is an open position, in which the passage through the orifice of the duct into the duct is open, and a second position is a closed position, in which the passage through the orifice of the duct into the duct is closed, and an actuating mechanism (6) for operating the shutter element.

7. An apparatus according to claim 6, characterized in that the actuating mechanism (6) operating the shutter element (5) comprises a cylinder-piston combination.

8. An apparatus according to claim 6, characterized in that the actuator (6) of the shutter element (5) is functionally connected to the supply of medium to the first spray head (2).

9. An apparatus according to claim 6, characterized in that the apparatus further comprises a temperature monitoring device (20) and that, based on an impulse obtained from this device, the shutter element (5) is moved to the second position, the closed position, when necessary.

10. An apparatus according to claim 6, characterized in that the apparatus further comprises at least one second spray head (21), which has been fitted to spray fire extinguishing medium in the space, preferably in the vicinity of the orifice of the duct (1), at least on the basis of the impulse given by the temperature monitoring device (20).

11. An apparatus according to claim 6, characterized in that the temperature monitoring device (20) is an ampoule designed to burst at a given temperature, as a result of the bursting of which ampoule a valve element (27) opens a passage (25) for the fire extinguishing medium to the second spray head (21) and/or causes a second valve element (16) to move so as to close the passage (18) to the first spray head (2) and/or to the actuator (6) of the shutter element.
